(19) United States
(12) Patent Application Publication
(10) Pub. No.: US 2020/0122021 A1
(43) Pub. Date: Apr. 23, 2020

(54) COMPUTER DEVICE AND COMPUTER IMPLEMENTED METHOD

(71) Applicant: KING.COM LIMITED, St. Julians (MT)

(72) Inventor: Andrew GORDON, Berlin (DE)

(21) Appl. No.: 16/167,805

(22) Filed: Oct. 23, 2018

(51) Int. Cl. A63F 3/00; A63F 13/2145; A63F 13/5378; A63F 13/80; G06F 3/0482

(52) U.S. Cl. CPC A63F 3/00643; A63F 13/2145; A63F 2300/1075; A63F 13/80; G06F 3/0482; A63F 13/5378

(57) ABSTRACT

A computer device is provided with a display which display a game board. The game board has nodes which are connected by paths defined by path elements. A user is able to obtain moves by selecting via a user interface an option which is associated with a computer implemented game and playing that game. User input is provided via the user interface. At least one processor is configured in response to the user input to move a game element around the game board using the moves which have been obtained by playing the game.

### FIELD OF THE INVENTION

Embodiments of this application relate to a user device for use in playing a computer implemented game.

Some embodiments may relate to engaging users or players in a computer game executable in an online environment.

### BACKGROUND OF THE INVENTION

In the field of computer-implemented games, there are many technical challenges facing the designer of such games when considering how, for example, the user interface is to be controlled in the context of computer devices available to play the game.

One technical challenge can involve allowing a game to be fun and compelling even when there is limited display resource available, such as when a game is being played on a smartphone, tablet or other minicomputer.

Another significant challenge is that of user engagement. Engagement involves designing gameplay to be engaging and rewarding to players. This typically requires games to be easily understood at their simplest or introductory levels, providing rewarding gameplay with quite simple game mechanics, but being more challenging and varied so that players are not bored, but remain engaged and develop rewarding skills.

Effective engagement requires various forms of feedback to reinforce a player's sense of success and accomplishment.

A common genre of casual games is so-called match games. This is a type of tile-matching game where the player manipulates tiles or game objects according to a matching criterion.

A match-three game is a type of casual puzzle game where the player is required to find patterns on a seemingly chaotic board. The player then has to match three or more of the same type of game element on the game board and those matched elements will then be removed from the game board.

An existing type of match-three game is a so-called “switcher” game. In a switcher game, the player switches the place of two adjacent game elements on the game board so that one or both of them create a chain of at least three adjacent game elements of the same type. Those matched game elements will then be removed from the game board. The game board is then repopulated with game objects.

Another known type of game is “linker game”, where a sequence of game elements are linked to form a known sequence.

Another type of game is a ‘clicker’ game, in which matches can be made in a board by clicking a group of adjacent game elements.

A technical challenge exists when introducing complexity and variety into such match games. A technical challenge may arise for example when there is limited display resource available and/or in the providing of effective user engagement, such as described previously.

Another significant technical challenge is how to retain casual game play where a user is able to play a game as and when they like while at the same time having an aspect which involves interaction with opponents.

This patent specification describes not only various ideas and functions, but also their creative expression. A portion of the disclosure of this patent document therefore contains material to which a claim for copyright is made and notice is hereby given: Copyright King.com Limited 2018 (pursuant to 17 U.S.C. 401). A claim to copyright protection is made to all screen shots, icons, look and feel and all other protectable expression associated with the games illustrated and described in this patent specification.

The copyright owner has no objection to the facsimile reproduction by anyone of the patent document or the patent disclosure, as it appears in the Patent and Trademark Office patent file or records, but reserves all other copyright rights whatsoever. No express or implied license under any copyright whatsoever is therefore granted.

### SUMMARY OF THE INVENTION

According to an aspect, there is provided a computer device comprising: a display configured to display a game board of a computer implemented game, the game board comprising a plurality of nodes which are each connected to a plurality of other nodes via at least one path element, a game element associated with a user being displayed at a first location on the game board on one of a path element and a node; a user interface configured to receive a first user input which selects an option associated with a game to be played; at least one processor configured in response to the game being played, providing a first number of moves for the game element, wherein the user interface is configured to receive a second user input, the at least one processor being configured, in response to the second input, to move the game element by up to the first number of moves and cause the display to display the game board with the game element at a second location on the game board based on moving of the game element by up to the first number of moves, the second location being on one of a path element and a node.

The at least one processor may be configured to move the game element along one or more nodes and one or more path elements.

Each move may correspond to one node or one path element.

The at least one processor may be configured to cause the display to display count information associated with the moves as the game element is moved.

The count information may comprise a remaining number of moves.

The at least one processor may be configured to cause the display to display the count information adjacent the game element.

The at least one processor may be configured to cause one or more nodes to be indicated on the display, the one or more indicated nodes being reachable from the first location using up to the first number of moves.

The second user input may provide a selection of one of the indicated nodes and the at least one processor may be configured to move the game element to the selected indicated node.

The at least one processor may be configured, when there are remaining moves, to cause one or more nodes and/or one or more path elements which use up the remaining moves to be indicated.

The user interface may be configured to receive a third user input selecting one of the indicated one or more nodes and/or one or more path elements which use up the remaining moves, and the at least one processor may be configured to move the game element to the selected one of the indicated one or more nodes and/or one or more path elements which use up the remaining moves.

The at least one processor may be configured to cause one or more nodes and/or one or more path elements which are the first number of moves from the first location to be indicated on the display.

The game board may comprise a plurality of paths between respective nodes, the at least one processor being configured to cause the display to display which of the plurality of paths on the game board are currently enabled.

The at least one processor may be configured to cause the currently enabled paths to be changed.

The at least one processor may be configured to cause the currently enabled paths to change randomly or pseudo randomly.

The at least one processor may be configured to cause at least one currently enabled path to include a current location of the game element.

The display may be configured to display a plurality of different options, each option being associated with a game, the user interface being configured to receive the first input selecting one of the plurality of options.

Each of the options may be associated with a respective number of moves, wherein when the game associated with the selected option is played, the at least one processor may be configured to provide the associated number of moves for the game element.

The game selected to be played may be associated with at least one objective, the at least one processor may be configured to provide the associated number of moves only if the at least one objective is satisfied when the game is played.

When an option is selected, the at least one processor may be configured to provide a further option from a set of available options.

The at least one processor may be configured to replenish the set of available options at a given rate.

The at least processor may be configured to visualize the plurality of options in association with a respective item selectable via the user interface.

The respective selectable item may comprise a card.

The computer implemented game may comprise a plurality of levels, the at least one processor is configured to transition to a next level in response to a given number of points being acquired.

A plurality of levels may require different numbers of points to be acquired to transition a next level.

The first n levels may require an increasing number of points in order to transition to that level with respect to a preceding level.

A plurality of levels may require a constant number of points to be acquired to transition to a next level.

In response to transitioning to a next level, the at least one processor may be configured to cause one or more of the following: a part of the game board is unlocked; a new game is available as a selectable option; a new game mode for one or more games is available; and an game booster for use in the game being played is provided.

The game board may comprise a plurality of areas, at least one of the areas being locked and at least one of the areas being unlocked, and the at least one processor may be configured to permit the game element to be only moved in one or more unlocked areas.

The at least one processor may be configured to cause one or more areas which are locked to be unlocked in response to satisfying of one or more criteria.

The display may be configured to display information relating to at least one other user on the game board.

The computer device may comprise a receiver configured to receive information about at least one other user from a server.

The information about at least one other user may comprise which of the plurality of nodes and path elements are associated with the at least one other user, and the display may be configured to display information about which of the plurality of nodes and path elements are associated with which user.

A plurality of different game boards may be provided and the at least one processor may be configured to permit the user to move the game element from one game board to another in response to at least one criteria being satisfied.

The at least one criteria may comprise one or more of: a current game board having all of its areas unlocked; a user having reached at least a given level; and the game element being at a given location on the map.

According to another aspect, there is provided a computer implemented method comprising: displaying on a display of a computer device a game board of a computer implemented game, the game board comprising a plurality of nodes which are each connected to a plurality of other nodes via at least one path element, a game element associated with a user being displayed at a first location on the game board on one of a path element and a node; receiving a first user input via a user interface of the computer device which selects an option associated with a game to be played; in response to the game being played, providing by at least one processor of the computer device a first number of moves for the game element; receiving a second user input via the user interface; in response to the second input, moving, by the at least one processor the game element by up to the first number of moves; and causing the display to display the game board with the game element at a second location on the game board based on moving of the game element by up to the first number of moves, the second location being on one of a path element and a node.

The method may comprise moving, by the at least one processor, the game element along one or more nodes and one or more path elements.

Each move may correspond to one node or one path element.

The method may comprise displaying on the display count information associated with the moves as the game element is moved.

The count information may comprise a remaining number of moves.

The method may comprise displaying on the display the count information adjacent the game element.

The method may comprise, causing by the at least one processor one or more nodes to be indicated on the display, the one or more indicated nodes being reachable from the first location using up to the first number of moves.

The second user input may provide a selection of one of the indicated nodes and the method may comprise, moving, by the at least one processor, the game element to the selected indicated node.

The method may comprise, causing by the at least one processor, when there are remaining moves, one or more nodes and/or one or more path elements which use up the remaining moves to be indicated.

The method may comprise receiving, via the user interface a third user input selecting one of the indicated one or more nodes and/or one or more path elements which use up the remaining moves, and the moving, by the at least one processor, the game element to the selected one of the indicated one or more nodes and/or one or more path elements which use up the remaining moves.

The method may comprise, causing by the at least one processor, one or more nodes and/or one or more path elements which are the first number of moves from the first location to be indicated on the display.

The game board may comprise a plurality of paths between respective nodes, and the method may comprise causing, by the at least one processor, the display to display which of the plurality of paths on the game board are currently enabled.

The method may comprise, causing by the at least one processor, the currently enabled paths to be changed.

The method may comprise, causing by the at least one processor, the currently enabled paths to change randomly or pseudo randomly.

The method may comprise, causing by the at least one processor, at least one currently enabled path to include a current location of the game element.

The method may comprise displaying on the display a plurality of different options, each option being associated with a game, and receiving via the user interface the first input selecting one of the plurality of options.

Each of the options may be associated with a respective number of moves, wherein when the game associated with the selected option is played, and the method may comprise providing by the at least one processor the associated number of moves for the game element.

The game selected to be played may be associated with at least one objective, and the method may comprise providing by the at least one processor the associated number of moves only if the at least one objective is satisfied when the game is played.

When an option is selected, the method may comprise providing by the at least one processor a further option from a set of available options.

The method may comprise, causing by the at least one processor, replenishing of the set of available options at a given rate.

The method may comprise, causing by the at least one processor visualization of the plurality of options on the display in association with a respective item selectable via the user interface.

The respective selectable item may comprise a card.

The computer implemented game may comprise a plurality of levels, and the method may comprise transitioning to a next level in response to a given number of points being acquired.

A plurality of levels may require different numbers of points to be acquired to transition a next level.

The first n levels may require an increasing number of points in order to transition to that level with respect to a preceding level.

A plurality of levels may require a constant number of points to be acquired to transition to a next level.

In response to transitioning to a next level, the method may comprise causing, by the at least one processor one or more of the following: a part of the game board is unlocked; a new game is available as a selectable option; a new game mode for one or more games is available; and an game booster for use in the game being played is provided.

The game board may comprise a plurality of areas, at least one of the areas being locked and at least one of the areas being unlocked, the method comprising permitting, by the at least one processor, the game element to be only moved in one or more unlocked areas.

The method may comprise, causing by the at least one processor, one or more areas which are locked to be unlocked in response to satisfying of one or more criteria.

The method may comprise displaying on the display information relating to the at least one other user on the game board.

The method may comprise receiving via a receiver information about at least one other user from a server.

The information about at least one other user may comprise which of the plurality of nodes and path elements are associated with the at least one other user, and the method may comprise displaying information about which of the plurality of nodes and path elements are associated with which user.

A plurality of different game boards may be provided and the method may comprise permitting by the at least one processor the user to move the game element from one game board to another in response to at least one criteria being satisfied.

The at least one criteria may comprise one or more of: a current game board having all of its areas unlocked; a user having reached at least a given level; and the game element being at a given location on the map.

According to some aspects, there is provided a program product comprising a computer-readable storage device including a computer-readable program for providing a computer-implemented game, wherein the computer-readable program when executed on a computer causes the computer to perform any one or more of the method steps described previously.

According to another aspect, there is provided a computer readable non-transitory storage medium carrying one or more computer executable instructions which when run on at least one processor cause: displaying on a display a game board of a computer implemented game, the game board comprising a plurality of nodes which are each connected to a plurality of other nodes via at least one path element, a game element associated with a user being displayed at a first location on the game board on one of a path element and a node; receiving a first user input which selects an option associated with a game to be played; in response to the game being played, providing a first number of moves for the game element; receiving a second user input; in response to the second input, moving the game element by up to the first number of moves; and causing the display to display the game board with the game element at a second location on the game board based on moving of the game element by up to the first number of moves, the second location being on one of a path element and a node.

A computer program comprising program code means adapted to perform the method(s) may also be provided. The computer program may be stored and/or otherwise embodied by means of a carrier medium.

In the above, many different embodiments have been described. It should be appreciated that further embodiments may be provided by the combination of any two or more of the embodiments described above.

### DESCRIPTION OF THE DRAWINGS

By way of example only, some embodiments will now be described with reference to the following Figure in which:

FIG. 1 shows a schematic view of a user device;

FIG. 2 shows an example computer environment;

FIG. 3 shows a game board of some embodiments;

FIGS. 4A to 4E show the unlocking of different areas of the game board of FIG. 3;

FIG. 5 shows a graph of points required to unlock a next level against current level;

FIGS. 6A to 6C shows an example visualization of a number of points to unlock a next level;

FIGS. 7A and 7B show example visualizations when a next level is unlocked;

FIG. 8A shows a map view with move cards;

FIG. 8B shows a move card screen view;

FIGS. 9A to 9E show some examples of cards;

FIGS. 10A to 10C show a series of moves made by a user;

FIG. 11A shows a move mode;

FIG. 11B shows an exploration mode;

FIG. 11C shows a preview mode;

FIG. 12 shows an example of node discovery;

FIGS. 13A to 13C show a competitive mode;

FIG. 14 shows a method for unlocking levels;

FIG. 15A shows move options for a player;

FIG. 15B shows an image displayed when moves have been used;

FIGS. 16A and 16B show a method of some embodiments;

FIG. 17A to 17C show a random path mode;

FIG. 18 shows another competitive mode; and

FIG. 19 schematically illustrates a mechanism for travelling between environments.

### DETAILED DESCRIPTION OF THE INVENTION

The terms user and player are used interchangeably throughout this document and no specific meaning is intended using one or the other unless the context suggests otherwise.

In the following description of various implementations of the invention, reference is made to the accompanying drawings which form part thereof, and in which is shown by way of illustration various implementations in which the invention may be utilized. It is to be understood that the other implementations may be utilized, and structural and functional modifications may be made without departing form the scope of the present invention.

A person skilled in the art will realise that the different approaches to implementing the game is not exhaustive, what is described herein are certain preferred embodiments. It is possible to implement the game in a number of variations.

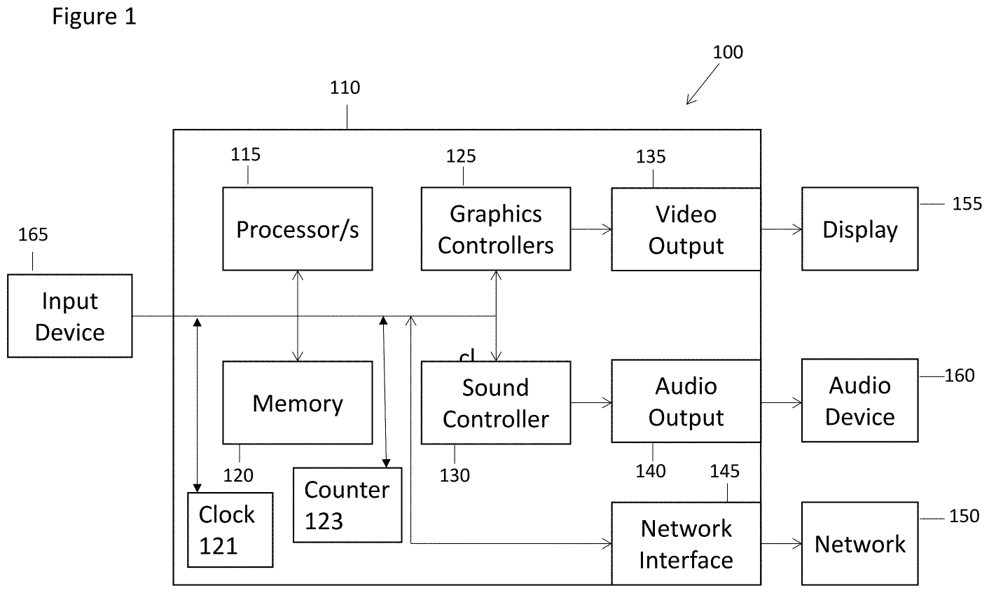

A schematic view of a user device 100 according to an embodiment is shown in FIG. 1. All of the blocks shown are implemented by suitable circuitry. The blocks may be implemented in hardware and/or software. The user device may have a control part 110 which may be provided by one or more processors 115 and at least one memory 120. The control part 110 is also shown as having a graphics controller 125 and a sound controller 130. It should be appreciated that one or other or both of the graphics controller 125 and sound controller 130 may be provided by the one or more processors 115.

The graphics controller 125 is configured to provide a video output 135. The sound controller 130 is configured to provide an audio output 140. The controller 110 has an interface 145 allowing the device to be able to communicate with a network 150 such as the Internet or other communication infrastructure.

The video output 135 is provided to a display 155. The audio out 140 is provided to an audio device 160 such as a speaker and or earphone(s).

The device 100 has an input device 165. The input device can take any suitable format and can be one or more of a keyboard, mouse, touch screen, joystick or game controller. It should be appreciated that the display 155 may in some embodiments also provide the input device 165 by way of an integrated touch screen for example.

The blocks of the controller 110 are configured to communicate with each other by an interconnect such as a bus or any other suitable interconnect and/or by point to point communication.

Optionally a counter 121 is provided. This may be implemented in hardware, software or by a combination of the two. The counter may be provided by the at least one processor in some embodiments.

Optionally, a clock 123 and/or timer function is provided. This may be implemented in hardware, software or by a combination of the two. The clock and/or timer function may be provided by the at least one processor in some embodiments.

It should be appreciated that in some embodiments, the controller may be implemented by one or more integrated circuits, at least in part.

The user device 100 is shown by way of example only. In alternative embodiments, one or more of the parts may be omitted. Alternatively or additionally, some embodiments may comprise one or more other parts. Alternatively or additionally, one or more parts may be combined.

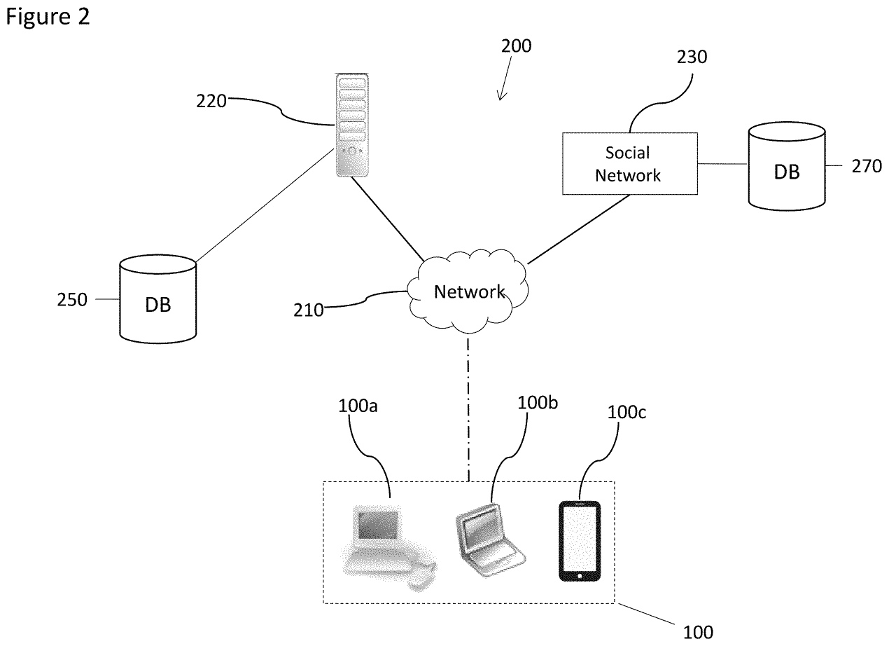

FIG. 2 schematically shows a system 200 according to an embodiment. The system 200 comprises a server 220 which may store or be in communication with database 250 which may store game player's details, profiles, statistics etc. In practice, one or more databases 250 may be provided. Where more than one server 220 is provided, the database(s) 250 may be provided in one server 220 or across two or more servers. The server 220 may also have a games data function. This may comprise one or more units of memory to store the computer game program, user behaviour data and a processor to run the games program and process the user behaviour data.

The server 220 may communicate via, for instance, the internet 210 to one or more client or user devices 100, shown in FIG. 2 by way of example as user devices 100a, 100b and 100c, and may further provide connections to a social network 230, for example, Facebook™. The social network 230 may also be connected to a database 270 storing social user interaction details, for instance, user to user interaction maps, friend lists, location history etc. In practice, one or more databases 270 may be provided.

It should be appreciated that embodiments may be deployed in different system architectures. For example, the computer game may be implemented as a computer game that is stored in the memory of the user device and is run on the processor of the user device. However, the server 220 may handle some elements of the game in some embodiments. By way of example only, a Java game applet may be provided to the user device 100 and the locally running Java applet will generate, for example, the graphics, sounds, and user interaction for the game play on the user device. Some data may be fed back to the server to allow interaction with other players. The data which is fed back may alternatively or additionally allow scoring and/or cross platform synchronization.

In some embodiments, the game may be implemented as a computer program that is stored in a memory of the system, for example the server, and which runs on a processor of the game server. Data streams or updates are supplied to the user device to allow the user device to render and display graphics and sounds in a browser of the user device. It should be appreciated, however, that such an approach does not necessarily require the use of the Internet. The game can be implemented solely as a computer program that is stored and runs entirely on one of many processors in a remote server, and data streams or updates are supplied to the client device (e.g. tablet, smartphone, etc.) to enable the client to render and display graphics and sounds; this ‘web services’ approach is increasingly common.

It should be appreciated that some embodiments may be provided as stand-alone games on the user device. For example, a computer game can be implemented as a computer program that is stored and runs entirely locally on the processor of a PC, games console, tablet or mobile telephone or other computing device.

The game can be implemented allowing a user to interact with it in different ways depending on the capabilities of the device which the user is accessing the game with. A user can interact with the game through using a touch screen where the user can select and/or move elements on the game board with a finger or for instance with a stylus. The game can also be played with a pointing device such as a mouse or other interaction devices such as keyboard.

Mobile devices may have a touch screen interface where the player can interact with the game using a finger or a pointing device such as a stylus. Some mobile devices have hard keys that complement the touch screen interface. Such hard keys may be in the form of a button or in the form of a joystick type of interaction.

Over the course of players playing the game, data will be produced. This data can for instance be related to a player's game performance or to game information related to a social network to which the game is connected. It is possible to gather this data, store it and make use of it for instance to improve the game.

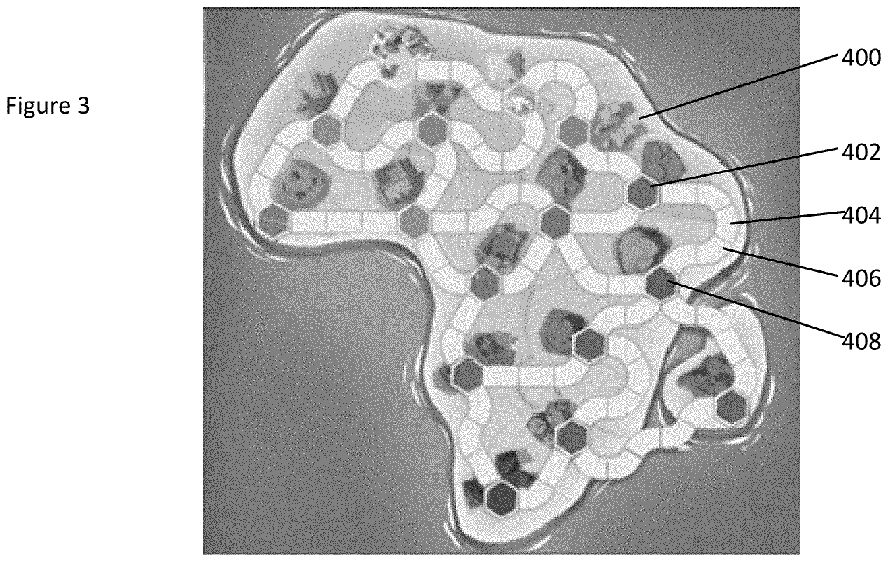

Reference is made to FIG. 3 which shows an example game board which is displayed on a display. The user is able to interact with this game board via the user interface. Where the user interface is provided by a touch screen as is the display, the user is able to interact with the game board by touching the screen.

In this example, the game board 400 is provided as a map of Africa. However, this is by way of example only and other embodiments may be provided in any suitable environment.

Generally the game board may be considered to provide a traversable or navigable environment which can be explored by the player while playing the game.

The game board 400 is made up of nodes 402. The nodes 402 are connected via paths 406. The paths are divided up into a series of individual path elements 404. Each path may comprise one or more path elements. In some embodiments, there are generally more than one path element between two nodes.

In some embodiments, movement from one path element to the next is considered to be one move or step. In other embodiments, movement from one path element to the next is considered to be more than one move. This will depend on the implementation of the game. Information about the nodes and path elements are stored in the memory. This information may comprise information about paths between the nodes.

As can be seen from FIG. 3, the nodes are each generally connected to at least two other nodes via respective paths. In some cases, a node is connected to more than two nodes. For example, node 408 is connected to four other nodes.

In some embodiments all the nodes are connected via respective paths to the same number of nodes. In other embodiments, the nodes are connected via respective paths to a variable number of nodes.

In some embodiments, the number of path elements between two nodes may always be the same. In other embodiments, the number of path elements between two nodes may be variable.

Where the nodes provide a navigation function, each node may be directly connected to at least two path elements.

A path element may be directly connected to two other path elements, one path element and one node or two nodes. In other embodiments, a path element may be directly connected to at least one further path element or node.

Movement along the path elements and nodes will be described in more detail later. The movement may be controlled by the at least one processor using information about the nodes and path elements stored in the memory.

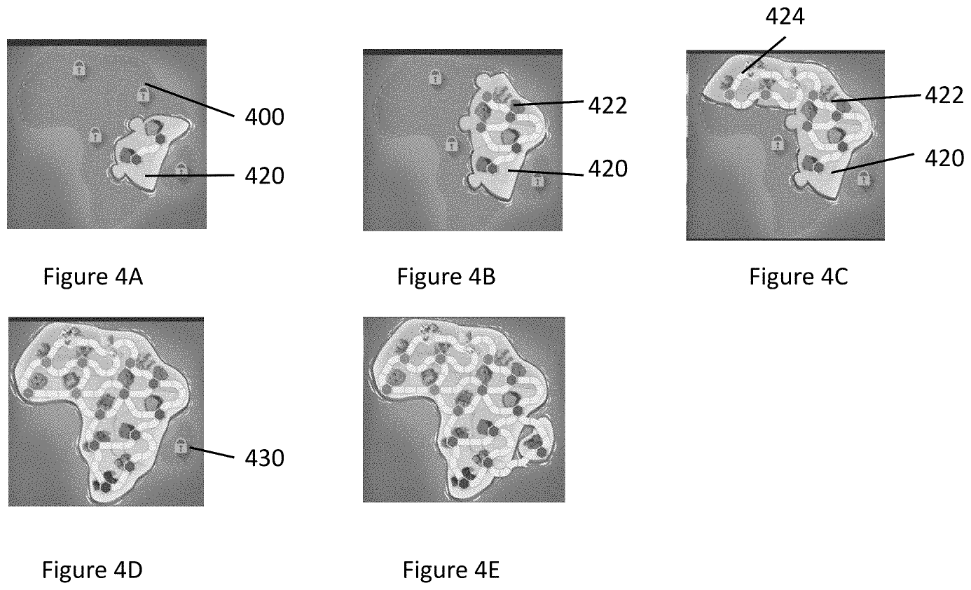

Reference is made to FIGS. 4A to 4E. These Figures show how in some embodiments, the game board displayed on the display is gradually unlocked to provide the unlocked game board of FIG. 3.

Referring first to FIG. 4A, a first area 420 of the game board 400 is unlocked. The remainder of the game board is locked. This means that when the user is playing the game, a game element of the user is only able to traverse the parts of the game board which are unlocked. It should be appreciated that any path element in the first area which leads from a node in the first area to a node in a locked area is not traversable by the game element of the user. The path element may not be displayed or may be displayed on the display in a way to indicate to the user that the path element is not traversable.

The part of the game board which is unavailable may be displayed on the display in such a way that it is clear to the user that the respective area or areas are locked. In some embodiments, an area which is locked may be greyed out and/or displayed with a padlock. It should be appreciated that this is by way of example only and in other embodiments any suitable visual representation may be used. For example a locked area may not be displayed. Information as to which areas are locked and which areas are unlocked may be stored in memory. This information may be used when providing the image which is displayed on the display. This information may be used by the at least one controller to control what moves are permitted for the game element of the user.

Some examples of how the different areas may be unlocked will be described later.

Reference is made to FIG. 4B which shows the game board where a second area 422 has additionally been unlocked. The second area is adjacent the first area. This means that when the user is playing the game, the game element of the user is able to traverse the first and second areas which are unlocked. The path elements in the first area which are on a path to a node in the second area will now be traversable by the game element of the player. Those path elements will either be displayed or displayed in such a manner to indicate to the user that the path element is now traversable.

FIG. 4C shows the game board where a third area 424 which has been unlocked.

It should be appreciated that in some embodiments, the areas which are unlocked may be adjacent to one another. Once an area is unlocked, the user is able to move their game element in the newly unlocked area and the previously unlocked area. In other embodiments, the areas may not be adjacent to unlocked areas to provide a further challenge to a player.

FIG. 4D shows the game board where most of the game board has been unlocked with a single locked area remaining. In the context of the example of the game board of FIG. 3, the one locked area represents the Island of Madagascar.

For completeness, FIG. 4E shows the unlocked game board of FIG. 3.

It should be appreciated that in some embodiments, there may be a plurality of areas in the locked area shown in FIG. 4C which need to be unlocked individually to get to the game board having a single locked area shown in FIG. 4D. Those different areas may be individually unlocked.

It should be appreciated that in some embodiments, the locked areas are individually unlocked. In some embodiments, two or more areas may be unlocked at the same time.

In some embodiments, to unlock these areas requires a user to reach or unlock an associated level. This is described in more detail later.

Information about which of the areas are locked and/or unlocked may be stored in memory and used when generating the image to be displayed on the display.

In some embodiments, there may be a plurality of navigable environments. Each of these navigable environments may provide a game board. Information about each of these environments may be stored in memory. The user may be able to move their game element between these different environments. Information may be stored in memory as to whether a user is permitted to navigate their game element between the environments and/or in what circumstances. In the context of the example shown in FIG. 3, one or more other navigable environments may be provided representing other continents.

In some embodiments, when a user has unlocked one environment, the user is then permitted by the at least one processor to start or completely unlock the next environment. In some embodiments, a user may be required by the at least one processor to completely unlock one environment before a next environment is even partially unlocked by the at least one processor. In other embodiments, the player may be permitted to move their game element to another environment by the at least one processor even if the current environment is not unlocked. In some embodiments, the ability of a game element to go to another environment may be dependent on the player reaching at least a certain level.

The user may be permitted by the at least one processor to navigate their game element between different environments via designated portal nodes or any other suitable mechanism.

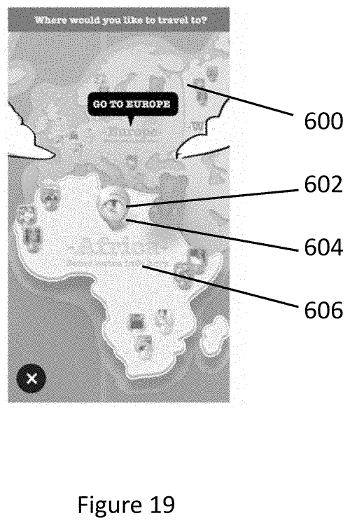

In this regard, reference is made to FIG. 19. In this embodiment, provided the at least one processor has determined that one or more criteria are satisfied, a user is able to use a transport mechanism provided by the at least one processor to move their game element between the different environments 600 and 606. This one or more criteria may be that the user has reached a given level and/or both environments (or continents) are at least partially unlocked.

In some embodiments, a user is able to select the transport mechanism by selection of an option via the user interface. In some embodiments, this can be regarded as summoning the transport to the user's game element location. In the example shown in FIG. 19, the transport mechanism is represented by a balloon 602. This is by way of example only, and other embodiments may use different representations.

In this embodiment, the user is permitted by the at least one processor to move their game element from any current location 604. In other embodiments, the user may be required by the at least one processor that their game element travel from one or more particular locations in their current environment 606 (Africa). This would require the user to move their game element to one or more of the particular locations.

In some embodiments, the user is permitted by the at least one processor to move their game element from their location in the current environment 606 to a fixed or one of a plurality of fixed locations in the next environment 600 (Europe).

In some embodiments, the user is able to select their destination in the next environment 600 or which of a plurality of other environments. For example, the user may select via the user interface which continent to visit. This selection may be provided when the user selects the transport option or when the transport arrives.

In some embodiments, the at least one processor may be configured to provide a delay before the game element associated with the user is transported. This may be because this mechanism is shared between the players and the player will need to wait his turn. In other embodiments, the delay may be dependent on the level that the player has reached. In other embodiments, there may be a fixed delay, which may be dependent on the level of the player. The player may be able to use in game currency and/or perform one or more tasks and/or use one or more rewards to reduce their waiting time. The length of the delay may be controlled by the at least one processor using the clock or timer function. The length of the delay may be set by the processor and/or may be based on information which has been received from the server. This information may relate to the other players.

The user may be provided with information about the destination and/or the likely delay in the transport arriving and/or the delay until the game element can move to the next environment. This information may be displayed on the display. This delay information may be updated as time elapses. There clock or counter may be used when providing that delay information. The delay information may comprise the amount of time until the transport arrives and/or the arrival time of the transport and/or the time until the game element can move to the next environment.

The length of time to travel between the environments may be relatively short.

In some embodiments, the available routes between environments may be dependent on the current level of the player.

In some embodiments, different players may be given different ones of the navigable environments as a starting environment.

In some embodiments, a player is able to select which of the navigable environments is to be their starting environment.

In some embodiments, the player may be part of a team and the player may be able to navigate any area which has been unlocked by the player or any other member of the team.

In some embodiments, an environment may not have any locked areas. In some embodiments, where there is more than one navigable environment, there optionally may be one or more criteria which need to be satisfied in order to allow the player to navigate their game element to another environment.

In some embodiments, the unlocking of a level is controlled by acquiring a certain number of points or other measure. The points may be experience points XP, in some embodiments. When the user reaches a particular number of points, a next level may be locked.

In some embodiments, the number of points may be reset by the at least one processor each time a user unlocks a level.

In some embodiments, each level may be associated with an accumulated number of points which are required to unlock that level.

It should be appreciated that in some embodiments, a different number of points may need to be acquired to unlock different levels.

In some embodiments, to provide a sense that the game is becoming more complex, the number of the points needed to be acquired to unlock each subsequent level may be generally larger than the preceding level. However, this is by way of example only and different numbers of points may need to be acquired to progress from one level to the next, in some embodiments.

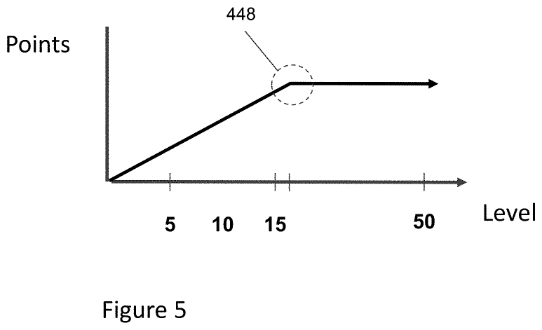

Reference is made to FIG. 5 which shows one embodiment of the relationship between the points which need to be acquired to move from one level to the next with respect to the current level. In this example, in order to progress to the next level, for the first 15 or so levels, the number of points which need to be acquired increases. In other words, the number of points required to go from level 5 to level 6 is less than the number of points required to go from level 14 to level 15. As indicated by reference number 448, after a given level, the number of points required to move from one level to the next is constant. It should be appreciated that this is by way of example only. Other embodiments may have different requirements between individual levels.

Other embodiments may have a similar pattern but the point at which the number of points required to go to the next level being constant may differ from that shown in this example.

In some embodiments, the number of points required to go from one level to the next may be constant.

In some embodiments, the player can continuously increase their level. In some embodiments, levels may be continuously added to the game in order to provide players with at least one level which they have not yet unlocked.

In some embodiments, points may be acquired as a result of one or more actions by the user. For example, the points can be acquired by moving the game element around the map and/or by visiting particular locations on the map. The mechanism by which the user moves their game element around the game board will be described in more detail later.

In some embodiments, when the game element of the user firsts visits a node during game play, the user may be provided with points or extra points for visiting that node.

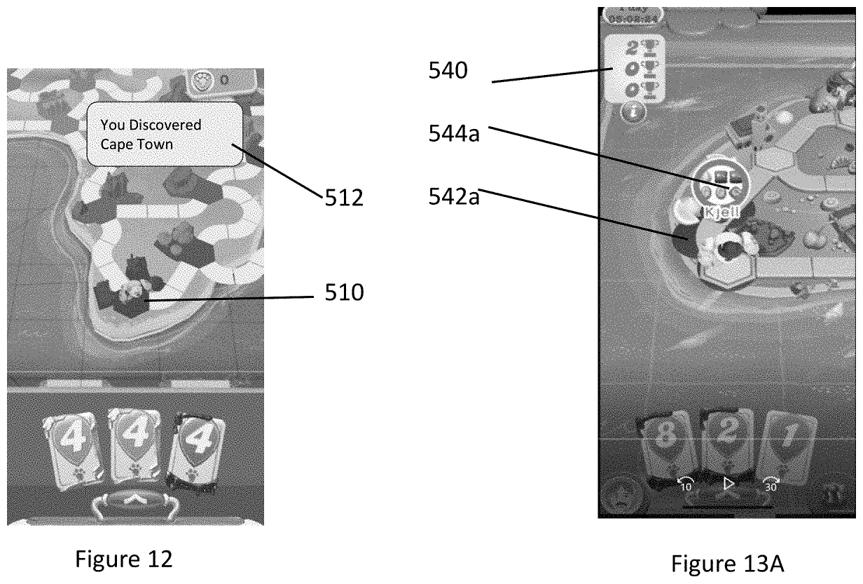

In some embodiments, a node may be associated with a location on the map. For example, in the image which is displayed on the display and shown in FIG. 12, node 510 may be associated with a particular location. In the example of the Africa map, node 510 may be associated with Cape Town. When the game element of the user reaches this node, the at least one processor is configured to provide a notification 512. The notification may comprise information about the location of the node and is displayed on the display. The notification may be dependent on information stored in the memory.

In some embodiments, when a node is reached a notification may be displayed on the display. The content of the notification may be dependent on the computer implemented game being played.

In some embodiments, the user may be set tasks by the computer implemented game and if the user takes part and/or complete that task, then the user may be provided with points.

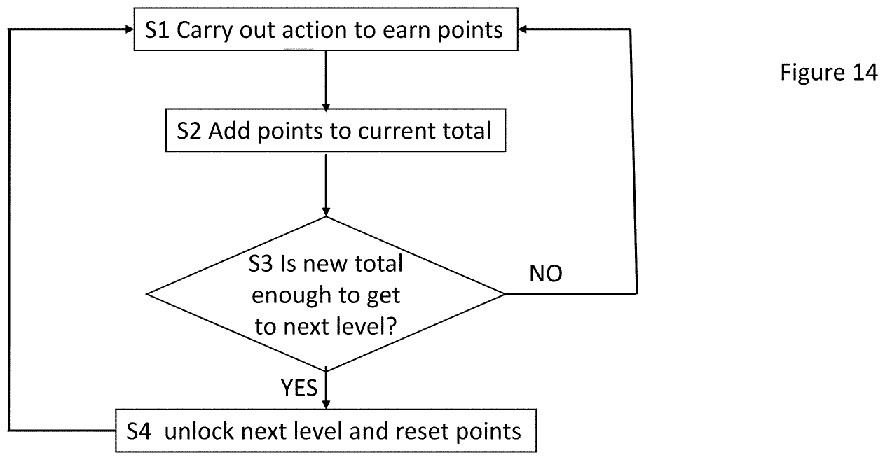

Reference is made to FIG. 14 which shows a method of some embodiments.

In step S1, the user interacts with the game via the user interface in such a way as to earn points. This may be to play a game to acquire moves, visit one or more particular nodes, visit a node for a first time, complete a task or any other suitable action.

In step S2, the at least one processor is configured to add the earned points to a current points total which may be stored in memory. The updated points total may be stored in memory.

In step S3, the at least one processor is configured to determine if the updated total is enough to unlock or to transition to the next level. This may be done by comparing the required points with the current points.

If not, the method loops back to step S1.

If so, the next step is step S4 and the next level is unlocked or made available by the at least one processor. In some embodiments, the points may be reset to zero by the at least one processor and the method loops back to step S1.

In embodiments which use accumulated points, the comparing by the at least one processor may be comparing the current points total to the required accumulated points total. In this example, there would be no resetting of the points to zero. Instead the next required accumulated points total may be retrieved from memory.

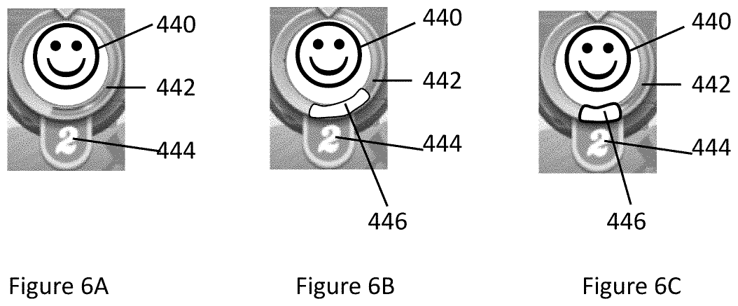

Reference is made to FIG. 6A which shows one example of displayed information about the player's current level. The information which is displayed on the display may be controlled by the at least one processor. In some embodiments, the user's avatar 440 may be displayed in a region of the display. The avatar may be surrounded by a ring 442. The extent to which the ring is filled indicates the user's progress in acquiring the points to unlock the next level. The determining of the extent to which the ring is filled may be by the at least one processor.

In some embodiments, the extent to which the ring is filled may be dependent on the ratio of the current points total to the total points required to upgrade to the next level.

In the arrangement shown in FIG. 6A, the current level is indicated via reference 444.

It should be appreciated that the manner in which this information can be displayed to the user is by way of example only. One or more of these pieces of information may be omitted. One or more of these pieces of information may be displayed in a different way.

Reference is made to FIG. 6B. This may be used when the user is about to perform a task or action or has completed an action which results in points. The part of the ring indicating the number of points has a portion 446 highlighted or displayed differently to the other parts of the ring or otherwise indicated. This portion may represent the number of points which the user can acquire or has acquired. Alternatively or additionally, these additionally points may be indicated numerically on the display.

In some embodiments, the highlighted part may be larger than the size which accurately represents the number of the points to be provided with respect to the ring. In this example, the highlighted part may then be shrunk to a size representing an accurate contribution to the total number of points, as shown in FIG. 6C. This image may be then be replaced by an image such as shown in FIG. 6A.

The position of the highlighted part in FIG. 6B and/or FIG. 6C may arranged such that the highlighted part does not extend beyond the point to which the ring should be filled once the points have been achieved.

In some embodiments, the image shown in FIG. 6B may be omitted.

In some embodiments, the enlarged highlighted part shown in FIG. 6B may be only provided if the amount of points relative to the total amount of points required is below a certain threshold. The determination as to whether or not the highlighted part is to be enlarged may be made by the at least one processor based on the number of points to be added with respect to the total number of points required to upgrade to the next level.

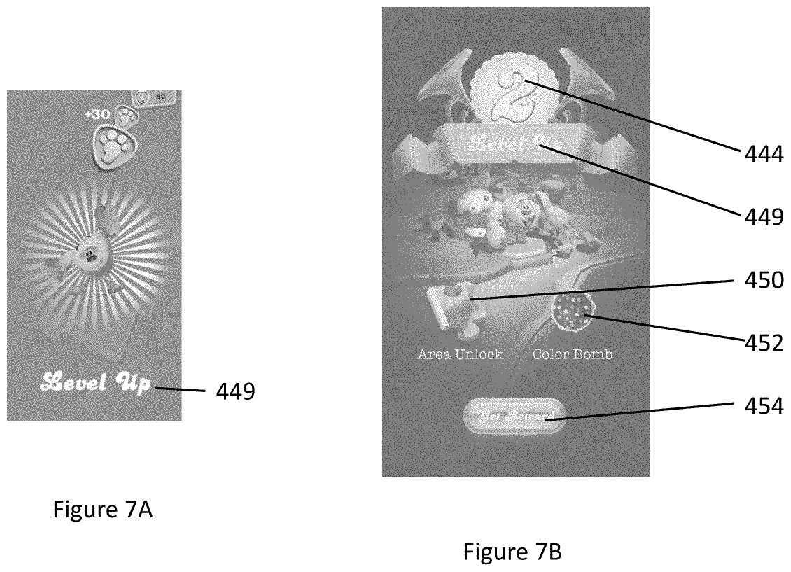

Reference is made to FIGS. 7A and 7B. In some embodiments, information may be provided to the player to indicate that they have acquired enough points to get to the next level. This information may be displayed on the display. In this regard reference is made to FIG. 7A which shows an image which is displayed on the display, with text 449 indicating that the player has unlocked the next level. The information which is to be displayed is controlled by the at least one processor.

In some embodiments, alternatively or additionally, the user is provided with information about the next level. In this regard, reference is made to FIG. 7B. This may be provided alternatively or additionally to the image displayed on the display shown in FIG. 7A.

This image displayed on the display may indicate to the user that a level has been unlocked (this is via the text “level up” referenced 449 in the example of FIG. 7B).

This image displayed on the display may indicate to a user the new level (level 2 and referenced 444 in the example of FIG. 7B).

In some embodiments, one or more different options may be associated with a new level. As mentioned previously, an area may be unlocked when a new level is unlocked. It should be appreciated that in some embodiments, a new area may not be unlocked with each new level. In this example an area is unlocked (as indicated by reference 450).

In some embodiments one or more rewards may alternatively or additionally be provided when a level is unlocked or attained. This reward may be used during game play. This may be indicated to the user, for example as referenced 452.

In some embodiments, a new game or new game mode may be available when a level is unlocked or attained.

In some embodiments, a player may only be able to have certain modes such as team or competitive modes once the player has reached a given level. This may be controlled by the at least one processor in conjunction with information stored in the memory about the given level.

In some embodiments, the user may be invited to claim the reward associated with the new level. In the example shown in FIG. 7B, an interaction area 454 is provided in the image which is displayed on the display. When the user interacts via the user interface with this area, the user may be provided with or have access to the associated rewards by the at least one processor.

The rewards provided by unlocking a level may comprise one or more of: one or more cards being replenished; one or more areas being unlocked; one or more new games; one or more new game modes; one or more player modes; one or more cards being upgraded; one or more game features being unlocked; in game currency; game booster; and availability of one or more different types of card. The use of cards in some embodiments is described later.

In current so-called Saga format games, a map view is used to indicate progress of a user. Each node on a pathway represents a current level, with the next node of the path representing a next level. In contrast, in some embodiments, the user moves a game element around the paths and nodes to acquire points which allow levels to be unlocked

The number of moves which a user is permitted to make by the at least one processor may depend on the value on a selected card or other selectable item.

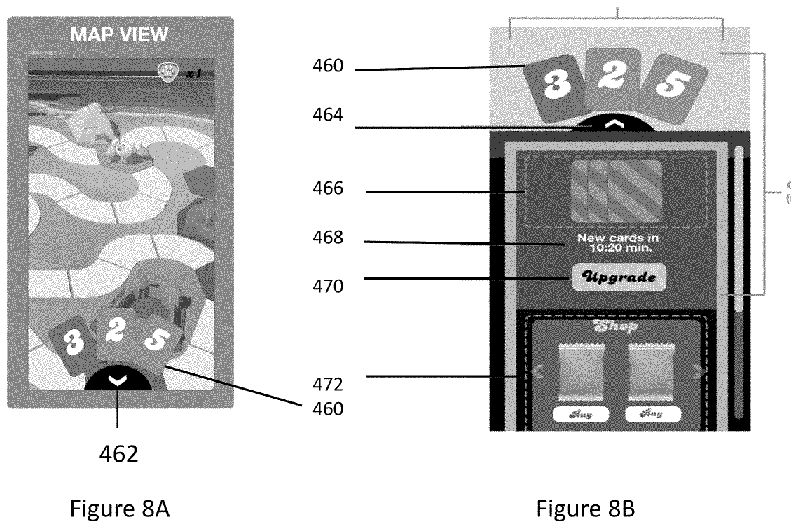

Reference is made to FIGS. 8A and 8B.

In FIG. 8A, three cards 460 are shown on the display. Each card has a value. The user selects one of the cards via the user interface and plays an associated game which is provided by the at least one processor. If the user is successful in achieving an objective of the associated game, the user is provided by the at least one processor with a number of moves corresponding to the value shown on the associated card.

In this example, the user is presented with three card options, which are displayed on the display. One of these card options is selected by the user via the user interface.

It should be appreciated that in other embodiments, the user may be simply presented with a single option. In other embodiments, the user may be provided with two or more options or cards.

In some embodiments, the different options are visualised using cards. However, it should be appreciated that this is by way of example only. In other embodiments, the available options may be visualised in any suitable manner as a selectable option.

In one embodiment, the image displayed on the display and shown in FIG. 8A has a so-called card deck area 462. When the user selects the card deck area via the user interface, the display is controlled by the at least one processor to display the image shown in FIG. 8B. The three cards 460 are shown.

The card (or option) mechanism is used to control the pacing of the game. By limiting the cards (or options) and the rate at which the cards (or options) are replaced, this may help drive user engagement. This may limit the moves that can be made on a game board within a given period. This pacing mechanism may make the players feel rewarded and fulfilled by playing the game. This pacing mechanism drives the engagement for casual game play creating an appointment mechanic for the players to return, after having allowed the card to be replenished.

In some embodiments, to control the pacing of the game, there may be a maximum number of cards (or options) provided within a given time period. For example, the user may be provided with a set of cards (or options). The number of cards which is in an initial card store can be set to a maximum number. Data on the number of cards which are stored in the store and/or data defining the cards may be stored in memory. In the arrangement of FIG. 8B, there are the three cards 460 in addition to the cards in a card store 466.

As the user plays the game, the cards are consumed. When a user selects a card and successfully plays a game, the associated card is removed from the three cards which are displayed on the display and another card may be taken from the card store. The data which is stored is updated. The card store may be replenished by the at least one processor over time. For example, a new card may be provided after a given period of time. This may be on a card by card basis in some embodiments or on a set of card basis in other embodiments. The amount of time until a new card is provided in the card store may be indicated by a timer 468 displayed to the user. The timer may be provided by a timer or clock of the device. In some embodiments, if the user consumes the cards so there are no cards left, the user will need to wait until the amount of time until the new card (or cards) is provided has been reached. The at least one processor which only provide another card or cards for selection by the user once the amount of time has been reached.

In some embodiments, the user may be able to use in game currency to upgrade to a next level or to upgrade cards and/or to have further card options and/or purchase an additional card. In some embodiments, an upgrade to the next level may only be possible using cards and not by using in game currency. Upgrading may be facilitated by an upgrade option 470 displayed on the display. When this option is selected by the user via the user interface, the user may be permitted by the at least one processor to upgrade the level and/or cards. In some embodiments an in-game shop 472 may be provided by the at least one processor to allow a user to purchase an additional card using in game currency.

One or other of the images displayed on the display and shown in FIGS. 8A and 8B may be omitted in some embodiments.

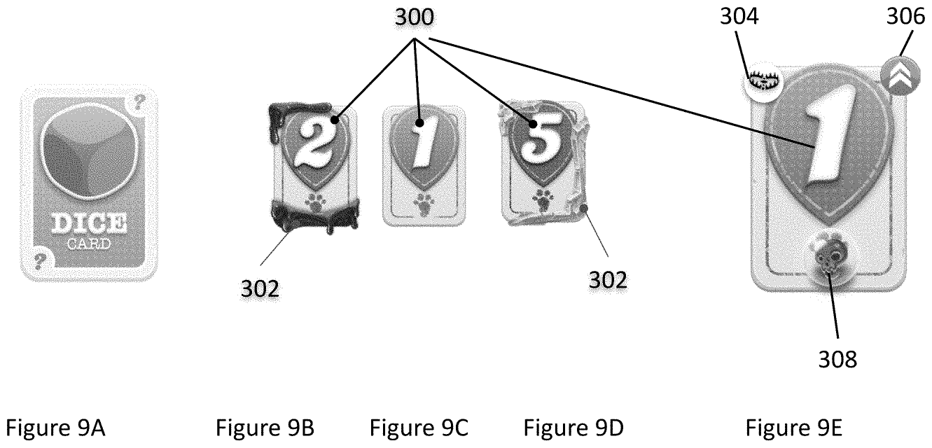

Reference is made to FIGS. 9A to 9E which shows some examples of cards or selectable items which may be provided in some embodiments. The cards which are provided may be dependent on a current level of the player.

In some embodiments, the cards shown in FIGS. 9B to 9E are provided with a number 300 which indicates the number of moves that are provided by that card.

When a user selects one of the cards shown in FIGS. 9B to 9E, the user is presented with a game to play. In some embodiments, the game may be associated with one or more game modes or different games. In some embodiments, the card may indicate an associated mode 302 of the game or one of the different games.

FIGS. 9B and 9D show examples of cards which indicate graphically a particular game mode. When the user selects the card the user is caused to play a game. The game may be any suitable game. By way of example, the game may be a match 3 type of game or any other suitable non match three game. The different modes may be different modes of these same underlying game. The different modes may for example require a different objective to be satisfied in order to complete the game. In some embodiments, different games may be provided. For example different types of match 3 games using different mechanics may be used. However, it should be appreciated, that embodiments are not limited to match 3 type games.

In addition to indicating the number of moves, in some embodiments, the number may be indicative of the difficulty of the associated game.

In some embodiments, a fixed number of moves may not be associated with a card. Rather the number of moves provided by the at least one processor may be dependent on one or more objectives achieved while playing the game. For example, where a game objective is to collect items or to remove items, the number of moves may be dependent on a number of items collected or removed. There may be a one to one relationship between the items collected or removed and the number of moves. In some embodiments, there may be a different relationship between the number of items collected and the number of moves provided.

Where a game objective is to earn game points or another representation of performance, the number of moves provided by the at least one processor may depend on the earned game points or other performance metric.

Where a game objective is to uncover tiles or to cause one or more game tiles to have a particular appearance or to change the appearance of one or more game tiles, the number of moves may be dependent on the extent to which the game objective is met. This may for example be dependent on the number of tiles which have met the particular objective.

In some embodiments, there may be a maximum number of moves associated with the card. Different ones of the cards may be associated with different numbers of maximum moves moves.

The cards associated with the variable number of moves may be instead of or as well as any previously described cards.

In some embodiments, the difficulty of a game may at least be partially dependent on the current player level.

In some embodiments, the modes of a game which are available may be at least partially dependent on the current player level.

In some embodiments, a user is able to achieve a reward when a user successfully plays a game associated with the card. The reward may be used when the user plays the game associated with the card, outside of the game play and/or when the user is navigating the map. For example the reward may be a particular type of booster or other reward. This may be indicated by an icon 306 on the card shown in FIG. 9E. In some embodiments, this reward may be provided if the game is successfully completed.

In some embodiments, a user is able to achieve a reward which can be used against opposing players in a competitive game. The reward may a trap or a weapon. This may be indicated by an icon 304 on the card shown in FIG. 9E. In some embodiments, this reward may be provided by the at least one processor if the game is successfully completed. In some embodiments there may be no moves associated with the card.

In some embodiments a game which is considered to be particular hard may be associated with a particular card. This may be indicated by an icon 308 on the card shown in FIG. 9E. The at least one memory may store information which indicates if a game is particularly hard. The at least one processor is configured to cause this information to be displayed on the display.

It should be appreciated that the card shown in FIG. 9E may be modified to have none, one or all of the associated icons and/or there may be no moves associated with a card.

Some embodiments may provide a card which has no game associated with it. In other words the player is not required to play a game in order to achieve the rewards associated with the game. An example of such a card is shown in FIG. 9A. In some embodiments, this card is referred to as a dice card. The providing of such cards may be controlled by the at least one processor.

This card may be provided at random in some embodiments. In some embodiments, the number of such cards or the probability of receiving a dice card may be dependent on the level.

In some embodiments, the user may be provided with these cards at predefined intervals. In some embodiments, these cards may be part of the card supply. In some embodiments, there may be a separate supply of dice cards which may be selected and used by the player. A pacing mechanism may be used to control the supply of these dice cards, such as previously described.

In some embodiments, one or more dice cards may be provided on the card deck. In some embodiments an unlimited supply of dice cards may be provided. In some embodiments, there may be an unlimited supply of dice cards until one or more movement cards are provided.

In other embodiments, there may be a limited number of dice cards provided.

In some embodiments, one of the options provided by the dice card may be to provide no reward.

In some embodiments, a reward may be earned but not provided until the level with which the reward is associated is unlocked.

In some embodiments, there may be a number of different potential rewards which may be obtained when that card is selected.

The reward which is provided may be extra points, extra moves, an in game item which can be used when the user plays the game and/or any other suitable reward. The providing of the reward may be controlled by the at least one processor.

The probability of getting a particular reward may be varied. This may be controlled by the at least one processor.

In some embodiments, the probability of getting a particular reward may be dependent on a current level.

In some embodiments, the rewards which are potentially available may be dependent on a current level.

The cards or options which are available may be dependent on the current level of the user.

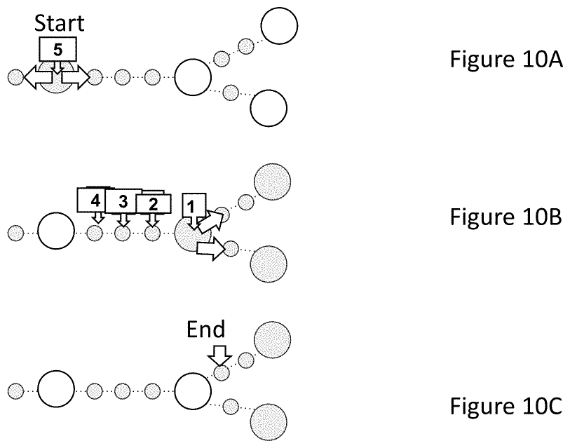

Reference is made to FIGS. 10A to 10C which shows how acquired moves may be used by a user. In this example, the user has selected via the user interface a card with the number 5, played the associated game and completed the associated objectives. The user is thus provided by the at least one processor with 5 moves to make. In particular, the user may be able to move a game element via the user interface with respect to the game board displayed on the display. The at least one processor is configured to allow the user to move the game element along the path elements and the nodes.

In FIGS. 10A to 10C, the nodes 402 are represented by the larger circles and the smaller circles represent the path elements 404.

In FIG. 10A, the initial position of a game element controlled by the user via the user interface is on the path element referenced “start”. The user is provided by the at least one processor with the option of moving the game element towards any one of the two nodes between which the path element is located. The available direction options may be indicated by arrows. The number of available moves may be displayed next to the game element. This number may be updated by the at least one processor as the game element is moved. The counter may be used to control the value which is displayed on the display.

In FIG. 10B, the user moves four spaces to a node. On each move, the number of available moves is decreased by the at least one processor. When the game element controlled by the user via the user interface reaches a node, the user is again prompted by the at least one processor to take one of the two paths to two further nodes. The at least one processor may be configured to cause arrows associated with each of the possible paths from the node to be displayed on the display. This node is connected to three other nodes (including the node from which the game element has traveled) via respective paths. The user is permitted by the at least one processor to move the game element via the user interface along any one of the three paths including the path on which the initial path element is provided. In other embodiments, the game element may be prevented by the at least one processor from being moved by the user via the user interface along an already traveled path. This may only be on a same turn in some embodiments or for a plurality of turns.

In some embodiments, a counter may be provided on the display by the at least one processor to show the number of remaining moves or the number of moves made. This counter maybe updated by the processor. In some embodiments, counter may be provided by the at least one processor or by a separate counter,

In some embodiments, such as illustrated in FIGS. 10A to 10C, the number of remaining moves may be shown on the display adjacent the game element being moved. In other embodiments, the number of moves used up or remaining may be shown separately from the game element being moved.

In some embodiments, when a node is reached, the user is prompted to select a direction option from a plurality of different available directions options. This may be by the at least one processor causing the display on the display of arrows and/or by highlighting available paths or path elements with respect to the game board.

As shown in FIG. 10C, the user takes the last move, via the user interface to cause the game element to end up on a path element which is referenced “end”. The user's turn is thus ended.

Thus in some embodiments, a user permitted by the at least one processor to cause the direction of a game element to change, including going back in the same direction which it has just come from, when a node is reached. The at least one processor is configured to cause the display to display the moves made by the game element responsive to the input from the user via the user interface.

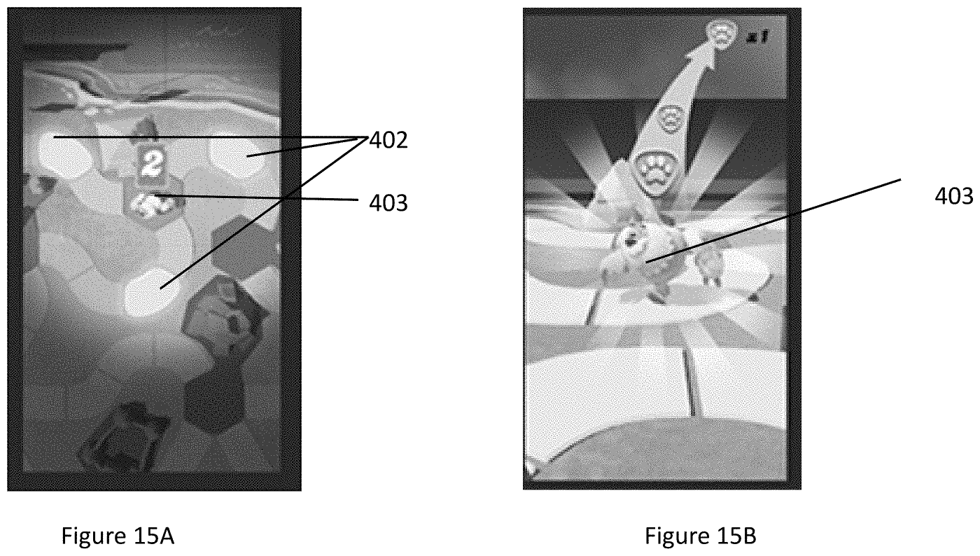

Reference is made to FIG. 15A which shows a modification to the movement mechanism described in relation to FIGS. 10A to 10C. In this embodiment, the game element 403 of the user is at a first location on the game board. In this example the user has two moves. The at least one processor is configured to highlight or otherwise indicate any node which is within 2 moves of the first location. The user interface is such that the user can select one of the highlighted nodes, for example by tapping the selected node and the game element will be moved to that node. As the game element is moved, the number of moves available is updated for each count. This may be used in those embodiments where a user is encouraged to stop at a node.

In some embodiments, there may be a different number of moves to different ones of the nodes.

In some embodiments, if a node on one path from the current node cannot be reached with the given number of moves, a path element on the path may be highlighted. This may be in addition to the highlighting of one or more other nodes.

In those embodiments where there are further moves available, when the user gets to the selected node, the options for using up at least some of those further moves may be displayed. The user interface is such that the user can select the end node or path element associated with an end move and the game element will be moved to that end node or path element. If there are enough moves to reach one or more nodes, the process set out above may be repeated.

It should be appreciated that in some embodiments, the at least one processor is configured to highlight any possible end node or path element which uses up all the allocated moves. The user interface is such that the user can select one of the end nodes or path elements and the game element will be moved to that end position.

In some embodiments, one aim may be to visit a set number of nodes.

In some embodiments one aim may be to visit a set number of nodes in a given order.

In some embodiments, one aim may be to collect items. The items may be provided at one or more nodes. The items may be collected by visiting the associated nodes.

One or more of the aims may provide the user with points.

One or more the aims may provide the user with an in game item or any other suitable reward.

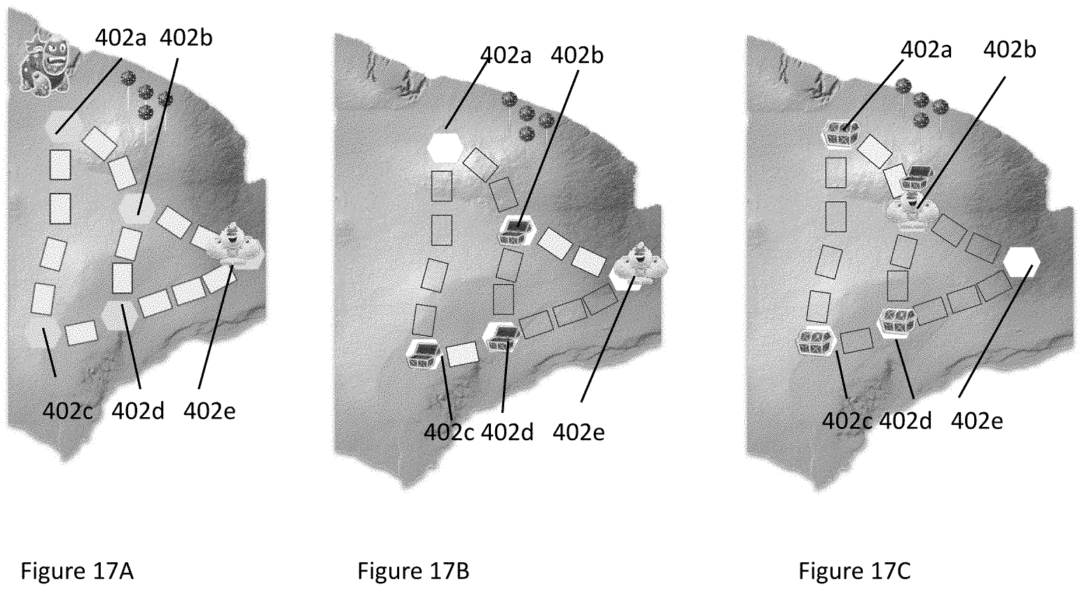

Reference is made to FIGS. 17A to 17C which shows an example of a mechanism which may be used in some embodiments. In some embodiments, the paths which are available or currently enabled and/or the path which appear on the map may vary. This may be from move to move or less frequently. This may be provided as an alternative or in addition to the previously described mechanisms. In some embodiments, the changing of the enabled paths may only be provided for some of the duration of the game or in a particular mode of the game.

References is made to FIG. 17A which shows the game element located on node 402e. Node 402e has paths to nodes 402d and 402c. Node 402d also has paths to nodes 402c and 402b. Node 402c also has a path to node 402a. Node 402a also has a path to 402b. All of these paths are available or enabled. In other words, provided there are sufficient moves, the game element can move along any of the paths.

In FIG. 17B, only the paths between nodes 402e and node 402b and between nodes 402c and 402d are available or enabled. The game element is located on node 402e

In FIG. 17C, only the path between nodes 402a and node 402b is available. The game element is located on node 402b.

The number of paths that are available or enabled for each turn may be the same or different.

The available or enabled paths may include in some embodiments a path from the node where the game element is located.

The path or paths which are provided in a turn may be random or appear to be random

In some embodiments, there may be one or more of the following input modes: movement mode, preview mode; and exploration mode. Each of these modes may have one or more restrictions as to how the player can interact with the nodes and paths. These restrictions may be controlled by the at least one processor.

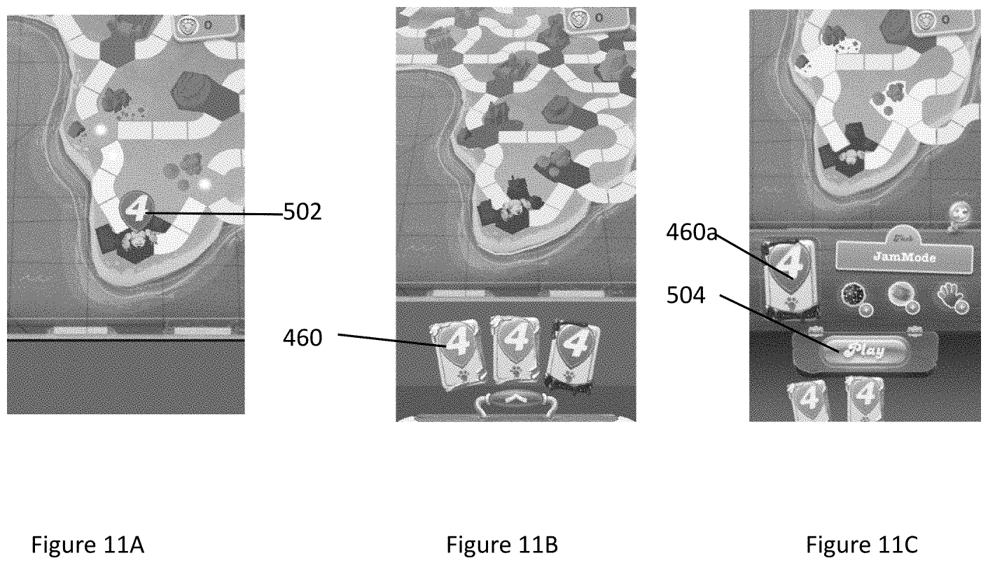

Referring first to FIG. 11A, this shows the movement mode. This is the mode as described for example in relation to FIGS. 10A to 10C and/or FIG. 15A. This mode may be automatically initiated after a player completes a game and acquires the associated moves. In some embodiments, the number of moves 502 remaining is displayed. In some embodiments, the paths which can be taken by the game element controlled by the user via the user interface, taking into account the number of available moves may be displayed in a visually distinct manner from those paths which cannot be used in that turn. In this mode, paths may only be interactable if they comprise a location that a player can reach with their moves.

Referring to FIG. 11B, this shows an exploration mode. In this mode, the possible cards which can be selected by a player are shown. The user has not at this stage selected any of these cards. The player has the freedom to move the camera angle by interaction with the user interface. The user may provide inputs via the user interface which may cause zooming in and/or out and/or panning the camera in a desired direction. The images which are displayed will be controlled by the at least one processor in response to the received inputs. This may be a default mode for the game. The paths may not be interactable in this mode.

Referring to FIG. 11C, this shows a preview mode. In this mode, the user has selected one of the cards 460a. The user is shown on the display one or more or all of the potential routes that the card can generate based on its number of moves. These potential paths may be displayed in a visually distinct manner as compared to the paths which are not available. The user can elect to play the game associated with the selected card by interacting with the area of the display inviting the user to play the game. Otherwise the user can deactivate this mode by deselecting the card via the user interface. The user may be returned to the exploration mode.

In some embodiments, a user has to use up all their moves in a turn. In some embodiments, a user is not able to store up moves across more than one turn. In other embodiments the user is able to store up moves across more than one turn.

In some embodiments, the player may play against one or more opponents and/or with one or more other players. The opponent or other players may be a computer generated component or AI (artificial intelligence) component. In some embodiments the computer generated component may be at least partially provide by the at least one processor and/or at least partially by the server. In other embodiments, a player may play in a team of one or more other players. This may be in a collaborative manner to achieve a particular aim or goal and/or against one or more teams. Information on the players in the teams may be stored at the server in the database and at least partially in the memory of the user device. The information which is stored may include game information for one or more of the team members.

The teams may have similar numbers. This may be controlled by the server. It should be appreciated that one or more of the team members may be provided by a computer generated component.

The aim of such games may be to win control of at least part of the game board or more of the game board than the opponent or opposing team. In some embodiments, each time a player of one team moves along a path, any path element or node of that path belongs to the team. This may be visualized on the display by having a different colour associated with each team. If a player of an opposing team subsequently moves along that path, any path element or node of that path belongs to the other team. The visualization of the path elements may be updated with for example the colour of the other team.

In some embodiments, the visualization associated with a team may be controlled by the at least one processer of the user's device. This allows a user to personalise their team. For example a user may select red as his team colour. The opposing team may be blue. However, when a member of the opposing team plays the game on their own device, their team colour may also be visualised as red.

Alternatively or additionally, each team needs to collect a set of objects. The objects may be the same or different for each team.

In some embodiments, one or more of the objects may be associated with one or more nodes and/or one or more path elements.

In some embodiments, the location of one or more objects may be static. Alternatively the location of one or more objects may move around the game board.

In some embodiments, one or more of the trap rewards may be used to capture one or more objects from another team and/or slow the progress of one or more members of the other team around the game board.

In some embodiments, a team may comprise a plurality of players playing against a computer opponent.

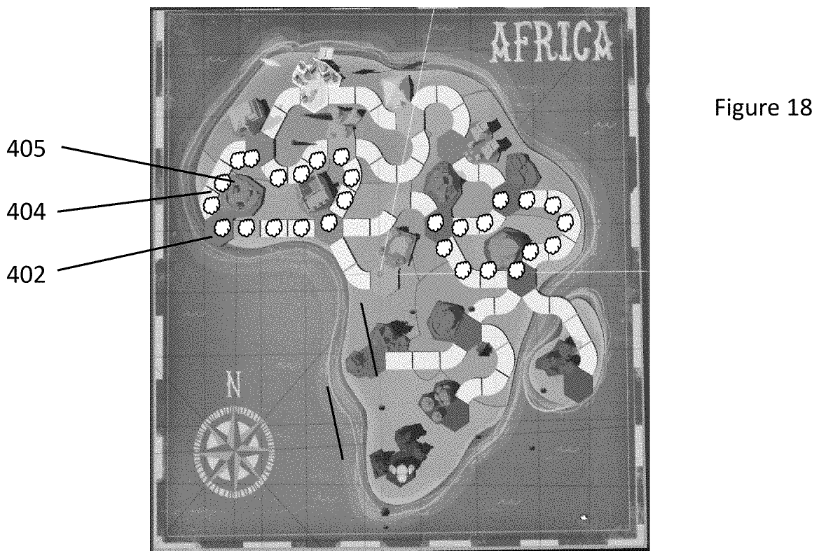

In some embodiments, the computer opponent may claim a proportion of a game area. The player or the team of players may attempt to claim back at least a proportion of that game area faster than the computer opponent can extend that game area. In this regard, reference is made to FIG. 18 which shows an example of such an embodiment. In this example, the computer opponent has covered some of the nodes 402 and path elements 404 with a respective layer 405 represented by circles in FIG. 18. The visualization of the layer may be any suitable visualization such as bubble-gum or the like. The layer provided on a respective node or path element may be a single layer or a plurality of layers. In some embodiments, where there are a plurality of layers, each layer may be removed when a player travels across the covered path element or layer. In some embodiments, different players may be required to remove different layers. In other embodiments, any member of the team may remove the layer. In some embodiments, initially the game board may be at least partially covered by the layer or layers on one or more of the nodes and path elements. The computer opponent may be triggered in response to an event or the lapsing of a given amount of time to provide more of the layers. The aim may be to remove at the layers from at least a part of the game board.

In some embodiments, where there is a team of players, one or more of the members of the team may be provided with individual goals. At least two members may be provided with different goals. In some embodiments, the goal may be dependent on the level of a respective team player. In some embodiments, different team members may be allocated different tasks in different parts of the game board.

In other embodiments, a team may be allocated a common goal.

In some embodiments there may be a collective common goal for a team and individual goals for the team players.

In some embodiments, where an aim may be to collect objects, one player may collect one or more objects such as previously described. That player may drop one or more objects at one or more given locations for collection by one or more other players.

In some embodiments, if two or more member of the same team pass each other on a path element or node, extra points or a reward may be provided. This may be visualised by a “high five”.

In those embodiments which involve playing against or with one or more other players, the user device is configured to receive data from one or more servers relating to those other players. The data may comprise data relating to the game progress of that other one or more players and data which relates to game identity of those other one or more players. The data which is received may be stored in memory and used by the at least one processor. Likewise the user device is configured to provide that data to the server for providing to the other players. This data may be frequently updated in some embodiments.

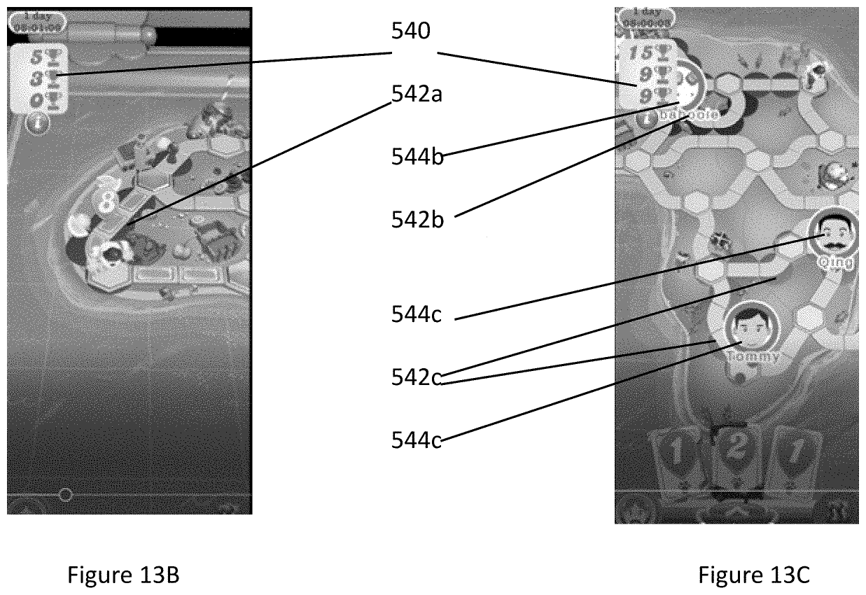

Reference is made to FIGS. 13A to 13C which shows a user interface. In this embodiment, a player has been invited or has joined a team.

Where a player is invited to join a team, the at least one processor may be configured to cause an invitation or other indication to be displayed on the display. The player is able to provide an input via the user interface to accept an invitation. In some embodiments, the at least one processor is configured to cause the invitation or other indication to be displayed on the display in response to information received from a server. The information may be received by a receiver of the computer device. The information may indicate that the user is to be invited to join a team. The information may optionally include information about one or more other team members. The information may optionally include information about one or other teams. The information may be provided at the same time or in a plurality of messages.

In some embodiments, the server may put the player into a team. The server may send information to the receiver of the computer device. The information may indicate that the user is in team. The information may optionally include information about one or more other team members. The information may optionally include information about one or other teams. The information may be provided at the same time or in a plurality of messages.

In the example shown in FIGS. 13A to 13C, there are three teams. The three teams may be each assigned a particular colour or other distinguishing characteristic. This may be done by the at least one processor or the server. Information about the teams' distinguishing characteristics may be stored in the memory. This information may be used by the at least one processor to control the image displayed on the image to reflect the respective distinguishing characteristics. This may be specific to the device as previously described.

The display may be configured to display information 540 about at least one and preferably all of the teams. In this embodiments, the progress of a team is represented by a numerical value. This numerical value may be stored in memory. This numerical value may be updated in response to information received by the computer device from the server and/or by the at least one processor in response to game play by the user. In some embodiments, the memory is configured to store information indicating which node and/or path elements belong to which team. This information is used to provide an image on the display which indicates which nodes and path elements belong to which team.

In some embodiments, this numerical value may be the number of path elements and nodes captured by a respective team. In the embodiment shown in FIG. 13A, the path elements and nodes 542a which have been captured are displayed on the display in a different way to those which have not been captured or those which have been captured by the other team. In some embodiments, a colour associated with a respective team may be provided on the path element or underlying the path element (as in the example of FIG. 13A). This colour may be the distinguishing characteristic.

As shown in FIG. 13A, a representation of other members 544a of the same team may also be shown on the map displayed on the display. The representation may be an avatar or the like. The representation may be such that it is clear to the player that the other player is on his team. This may be by means of a ring around the avatar in the team colour or in any other suitable way. Information about the representations to be used for the other players may be received from the server in some embodiments.

Reference is made to FIG. 13B. The user has selected a card via the user interface, played the associated game and obtained 8 moves which the user is in the process of taking. As the game element associated with the player moves across a path element or node, the path element or nodes 542a will be displayed in association with the player's team colour.

Reference is made to FIG. 13C which shows more of the game board which is displayed on the display. This shows a player 544b of a second team with those path elements or nodes 542b which have been gained by the second team and which are displayed in association with the colour of the second team.

Also shown are two members 544c of the third team. Those path elements or nodes 542c which have been gained by the third team are displayed in association with the colour of the third team.

It should be appreciated that in some embodiments, the numbers of teams may be more or less than three teams.

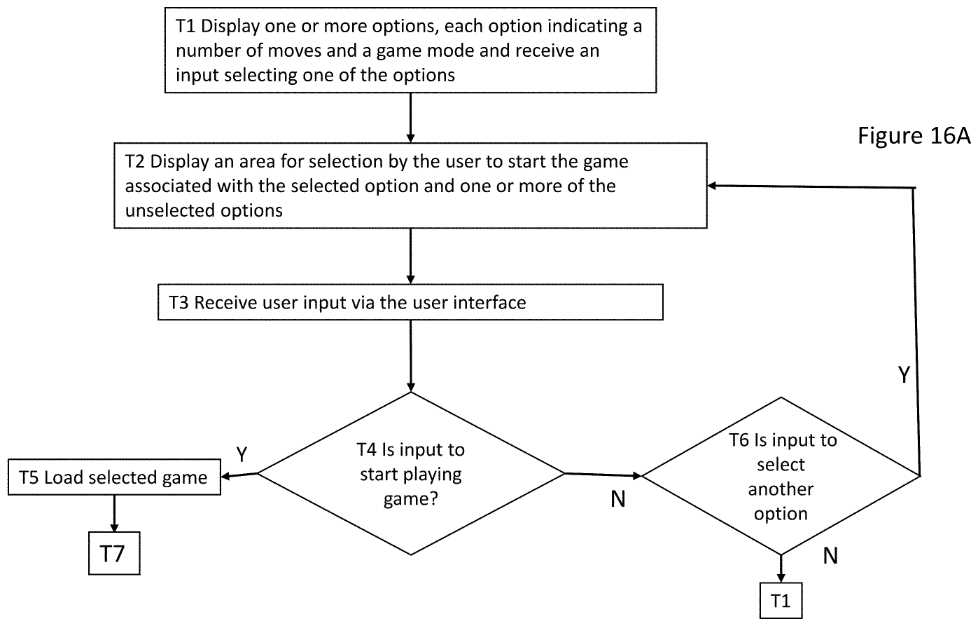

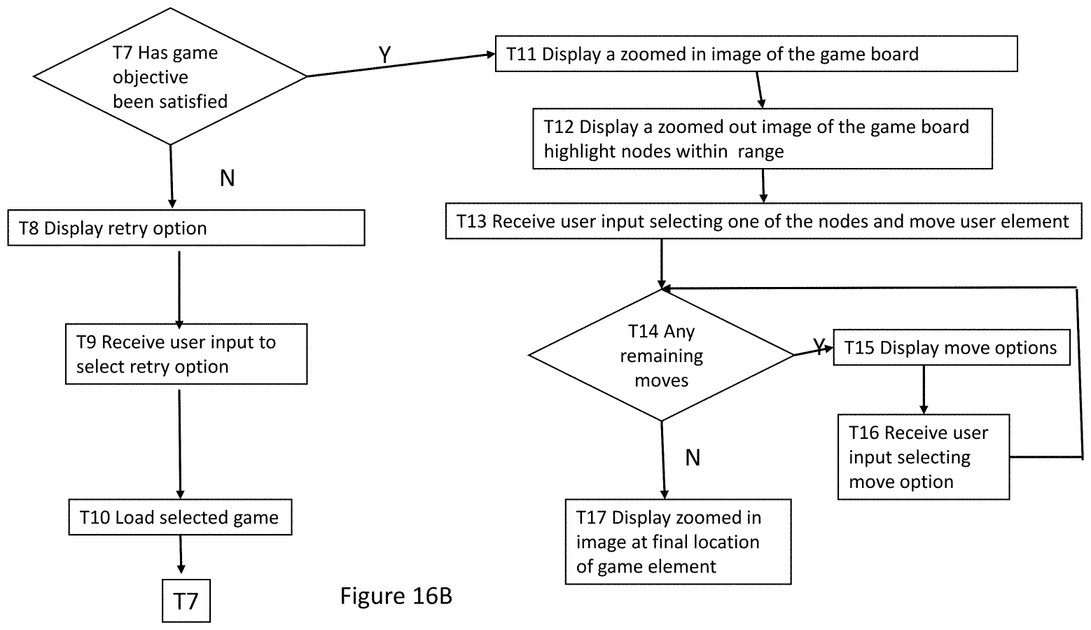

Reference is made to FIGS. 16A and 16B which show a method of some embodiments.

In step T1, the at least one processor is configured to cause the display to display or one or more options. Each option may indicate a number of moves. Alternatively or additionally, an option may indicate an associated game or game mode. In some embodiments, the options may be displayed as cards, such as previously described. In some embodiments, a plurality of different options are displayed. In other embodiments, there may be a single option displayed.

The options are displayed in such a way that the user is able to select one of the displayed options via the user interface. Where the display and the user interface are provided by the touch screen, an option may be selected by the user touching that displayed option.

In step T2, the selecting of the option by the user via the user interface is configured to cause an area to be displayed on the display which invites the user to select that area to start the game. The causing of the area to be displayed is by the at least one processor. The display may be further configured to also show one or more of the unselected options. This may be controlled by the at least one processor.

In step T3, the user interface is configured to receive a user input.

In step T4, the at least one processor is configured to determine if the user input is to select the option to start playing the game.

If so, the next step is step T5 in which the selected game is loaded by the at least one processor and is played by the user. The game is controlled by the at least one processor in response to inputs received from the user via the user interface.

Step T5 is followed by step T7 of FIG. 16B. This will be described in more detail later.

Going back to step T4, if it is determined by the at least one processor that the input is not to select the option to start playing the game, then the next step is step T6.

In step T6, the at least one processor is configured to determine if the user input is selecting another of the options. In other words, has the user changed their mind as to the selected option and is selecting one of the other options. If so, step T6 is followed by step T2. If not, step T6 is followed by step T1.

It should be appreciated that in some embodiments, allowing the user to change the selected option may be optional. In those embodiments, step T1 one may be simply followed by step T5.

In some embodiments, steps T4 and T5 may be combined or carried out in any order.

In step T7, it is determined by the at least one processor if the game objective has been satisfied. If not, then the next step is step T8.

In step T8, the at least one processor is configured to cause an area to be displayed on the display which can be selected by the user via the user interface to allow the game to be retried.

In step T9, a user input via the user interface is received which selects the retry option.

In response to the selection of the retry option, the at least one processor is configured to load the selected game in step T10.

Step T10 is then followed by step T7.

In some embodiments, step T7 may be followed by step T1 instead of steps T8, T9 and T10.

Going back to step to step T7, if it is determined by the at least one processor that the game objective has been satisfied, then step T7 is followed by step T11.

In step T11, the at least one processor is configured to cause the display to display a zoomed in image of the game board at the location of the game element of the user. This game element may be an avatar or any other suitable representation of the user or any other suitable game element. This step may be optional in some embodiments.

In step T12, the at least one processor is configured to cause the display to display a zoomed out image of the game board highlighting all (or at least one or some) of the nodes which are within range of the location of the game element given the number of moves which are available. One move may equate to moving from one path element to the next, from one path element to a node and/or from one node to a path element. The zooming out may be optional in some embodiments. This may be as described in relation to FIG. 15A.

In step T13, the at least one processor is configured to determine that the user input via the user interface has selected one of the nodes. The game element of the user is then moved to the selected node. This is controlled by the at least one processor. The game element may be displayed on the display at the selected node.

In step T14, it is determined by the at least one processor if there are any remaining moves.

If so, the next step is step T15. The at least one processor will cause the display to display further move options available to the user. This may comprise path elements and/or nodes.

In step T16, the user input selecting one of the move options is received via the user interface. Step T16 is then followed by step T14.

In some embodiments, one or more of steps T14, T15 and T16 may be optional.

If in step T14, it is determined by the at least one processor that there is no more moves, then the next step is step T17. In step T17, the at least one processor is configured to display a zoomed in image at the location of the game element at the end of the move. In this regard, reference is made to FIG. 15B which shows such an image which is displayed on the display. The image may comprise the game element 403 and a visualization which conveys that moves have been completed. This may be optional in some embodiments. The zooming in may be optional in some embodiments. It should be appreciated that in other embodiments a different visualization may be used on the display to convey that there are no more moves or that the moves have been completed.

Various methods and devices have been described. It should be appreciated that these methods may be implemented in apparatus or devices comprising any suitable circuitry. Some embodiments may be implemented by at least one memory and at least one processor. The memory is provided by memory circuitry and the processor is provided by processor circuitry. Some embodiments may be provided by a computer program running on the at least one processor. The computer program may comprise computer implemented instructions which are stored in the at least one memory and which may be run on the at least one processor. A computer program product may be provided which comprises computer program product comprising code embodied on a computer-readable medium which is configured to be executed on a processor of the computer or user device. In some embodiments, a non-transitory computer readable storage device may be provided to store program code instructions that, when executed by at least one processor causes any of the above described methods to be performed.

A person skilled in the art will realise that the different approaches to implementing the game is not exhaustive, what is described herein are certain preferred embodiments. It is possible to implement the way in a number of variations without departing from the scope of the invention as claimed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer device comprising:
a display configured to display a game board of a computer implemented game, the game board comprising a plurality of nodes which are each connected to a plurality of other nodes via at least one path element, a game element associated with a user being displayed at a first location on the game board on one of a path element and a node;
a user interface configured to receive a first user input which selects an option associated with a game to be played;
at least one processor configured in response to the game being played, providing a first number of moves for the game element,
wherein the user interface is configured to receive a second user input, the at least one processor being configured, in response to the second input, to move the game element by up to the first number of moves and cause the display to display the game board with the game element at a second location on the game board based on moving of the game element by up to the first number of moves, the second location being on one of a path element and a node.

2. The computer device as claimed in claim 1, wherein the at least one processor is configured to move the game element along one or more nodes and one or more path elements.

3. The computer device as claimed in claim 1, wherein the at least one processor is configured to cause the display to display count information associated with the moves as the game element is moved.

4. The computer device as claimed in claim 1, wherein the at least one processor is configured to cause one or more nodes to be indicated on the display, the one or more indicated nodes being reachable from the first location using up to the first number of moves.

5. The computer device as claimed in claim 4, wherein the second user input provides a selection of one of the indicated nodes and the at least one processor is configured to move the game element to the selected indicated node.

6. The computer device as claimed in claim 5, wherein the at least one processor is configured, when there are remaining moves, to cause one or more nodes and/or one or more path elements which use up the remaining moves to be indicated.

7. The computer device as claimed in claim 5, wherein the user interface is configured to receive a third user input selecting one of the indicated one or more nodes and/or one or more path elements which use up the remaining moves, and the at least one processor is configured to move the game element to the selected one of the indicated one or more nodes and/or one or more path elements which use up the remaining moves.

8. The computer device as claimed in claim 1, wherein the at least one processor is configured to cause one or more nodes and/or one or more path elements which are the first number of moves from the first location to be indicated on the display.

9. The computer device as claimed in claim 1, wherein the game board comprises a plurality of paths between respective nodes, the at least one processor is configured to cause the display to display which of the plurality of paths on the game board are currently enabled.

10. The computer device as claimed in claim 9, wherein at least one processor is configured to cause the currently enabled paths to be changed.

11. The computer device as claimed in claim 10, wherein the at least one processor is configured to cause at least one currently enabled path to include a current location of the game element.

12. The computer device as claimed in claim 1, wherein the display is configured to display a plurality of different options, each option being associated with a game, the user interface being configured to receive the first input selecting one of the plurality of options.

13. The computer device as claimed in claim 12, wherein each of the options is associated with a respective number of moves, wherein when the game associated with the selected option is played, the at least one processor is configured to provide the associated number of moves for the game element.

14. The computer device as claimed in claim 13, wherein the game selected to be played is associated with at least one objective, the at least one processor is configured to provide the associated number of moves only if the at least one objective is satisfied when the game is played.

15. The computer device as claimed in claim 12, wherein when an option is selected, the at least one processor is configured to provide a further option from a set of available options.

16. The computer device as claimed in claim 15, wherein the at least one processor is configured to replenish the set of available options at a given rate.

17. The computer device as claimed in 12, where the at least processor is configured to visualize the plurality of options in association with a respective item selectable via the user interface.

18. The computer device as claimed in claim 1, wherein the computer implemented game comprises a plurality of levels, the at least one processor is configured to transition to a next level in response to a given number of points being acquired.

19. The computer device as claimed in claim 18, wherein in response to transitioning to a next level, the at least one processor is configured to cause one or more of the following:
a part of the game board is unlocked; a new game is available as a selectable option; a new game mode for one or more games is available; and an game booster for use in the game being played is provided.

20. The computer device as claimed in claim 1, wherein the game board comprises a plurality of areas, at least one of the areas being locked and at least one of the areas being unlocked, the at least one processor being configured to permit the game element to be only moved in one or more unlocked area.

21. The computer device as claimed in claim 21, wherein the at least one processor is configured to cause one or more areas which are locked to be unlocked in response to satisfying of one or more criteria.

22. The computer device as claimed in claim 1, wherein the display is configured to display information relating to at least one other user on the game board.

23. The computer device as claimed in claim 22, comprising a receiver configured to receive information about at least one other user from a server.

24. The computer device as claimed in claim 22, wherein the information about at least one other user comprises which of the plurality of nodes and path elements are associated with the at least one other user, the display being configured to display information about which of the plurality of nodes and path elements are associated with which user.

25. The computer device as claimed in claim 1, wherein a plurality of different game boards are provided, the at least one processor being configured to permit the user to move the game element from one game board to another in response to at least one criteria being satisfied.

26. The computer device as claimed in claim 25, wherein the at least one criteria comprises one or more of:
a current game board having all of its areas unlocked; a user having reached at least at a given level; and the game element being a given location on the map.

27. A computer implemented method comprising:
displaying on a display of a computer device a game board of a computer implemented game, the game board comprising a plurality of nodes which are each connected to a plurality of other nodes via at least one path element, a game element associated with a user being displayed at a first location on the game board on one of a path element and a node;
receiving a first user input via a user interface of the computer device which selects an option associated with a game to be played;
in response to the game being played, providing by at least one processor of the computer device a first number of moves for the game element;
receiving a second user input via the user interface;
in response to the second input, moving, by the at least one processor the game element by up to the first number of moves; and
causing the display to display the game board with the game element at a second location on the game board based on moving of the game element by up to the first number of moves, the second location being on one of a path element and a node.

28. A computer readable non-transitory storage medium carrying one or more computer executable instructions which when run on at least one processor cause:
displaying on a display a game board of a computer implemented game, the game board comprising a plurality of nodes which are each connected to a plurality of other nodes via at least one path element, a game element associated with a user being displayed at a first location on the game board on one of a path element and a node;
receiving a first user input which selects an option associated with a game to be played;
in response to the game being played, providing a first number of moves for the game element;
receiving a second user input;
in response to the second input, moving the game element by up to the first number of moves; and
causing the display to display the game board with the game element at a second location on the game board based on moving of the game element by up to the first number of moves, the second location being on one of a path element and a node.
